(19) United States
(12) Patent Application Publication
(10) Pub. No.: US 2018/0287552 A1
(43) Pub. Date: Oct. 4, 2018

(54) Solar Panel Cleaner

(71) Applicant: James Tomlinson, Houston, TX (US)

(72) Inventor: James Tomlinson, Houston, TX (US)

(21) Appl. No.: 15/591,102

(22) Filed: May 9, 2017

Related U.S. Application Data
(63) Continuation-in-part of application No. 14/811,789, filed on Jul. 28, 2015, now abandoned.
(60) Provisional application No. 62/029,992, filed on Jul. 28, 2014.

(51) Int. Cl. H02S 40/10; H02S 40/42; B08B 3/02; B08B 3/14; B08B 1/00

(52) U.S. Cl. CPC H02S 40/10; H02S 40/42; B08B 1/005; B08B 3/14; B08B 3/02

(57) ABSTRACT

A solar panel cleaning device comprises a Peltier refrigerator mounted onto the top of a solar panel wherein the Peltier refrigerator is positioned such that condensation formed by the Peltier refrigerator will flow over the solar panel's surface.

This application is a continuation in part of application number 14/811,789 which claims the benefit of provisional patent application number 62/029,992.

### BACKGROUND

The invention generally pertains to devices to clean or rinse solar panels automatically to maximize power output.

### BRIEF DESCRIPTION OF THE DRAWING

FIG. 1 shows an embodiment comprising a self-cleaning solar panel.

These and other features, aspects, and advantages of an embodiment will become better understood when the following detailed description is read with reference to the accompanying drawings in which like characters represent like parts throughout the drawings.

### DESCRIPTION

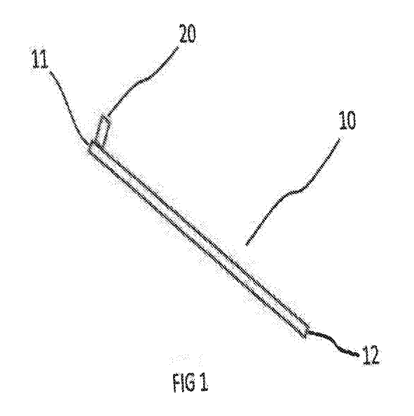

FIG. 1 shows an embodiment that comprises a self-cleaning solar panel 10 having a top end 11 and a bottom end 12 with a Peltier refrigerator 20 mounted onto the solar panel's top end 11 wherein the Peltier refrigerator 20 is positioned such that condensation formed by the Peltier refrigerator 20 will flow over the solar panel's surface from the solar panel's top end 11 to the solar panel's bottom end 12.

By use of a Peltier refrigerator 20, dew will be formed at the top 11 of a panel 10 which will flow down to the bottom 12 of the panel 10 thereby rinsing the panel 10 and removing dust or other material that would otherwise block sunlight from reaching the panel 10.

An embodiment could further comprise a heat sink ta manage Peltier refrigerator 20 temperature. Cycling the unit could be detrimental, since the Peltier refrigerator would build up heat. When a Peltier refrigerator is switched off, it gets hot. A heatsink may be required for certain embodiments.

An alternative embodiment could further comprise a pressurized system with at least one nozzle pointed toward the solar panel 10. The pressurized water system could store water formed by the Peltier refrigerator 20 and then spray the water created by the Peltier refrigerator 20 through the nozzle onto the solar panel 10. A pressurized jet of water could thereby be created and stored then pumped and sprayed, adding the water jet's kinetic energy to the cleaning operation.

An embodiment as shown in FIG. 1 could further comprise a light sensor to determine dirtiness of the self-cleaning solar panel 10 and when required, activate the Peltier refrigerator 20 to clean the solar panel 10.

An embodiment as shown in FIG. 1 could further comprise a timer system to start cleaning at night to make forming dew easier. Such an embodiment could further comprise a battery system to store energy that the Peltier refrigerator 20 uses for a cleaning cycle. The system could be operated without a “dirty” sensor, which means a cleaning cycle every night, ensuring cleanliness.

An embodiment could comprise a light sensor, a timer that determines that cleaning takes place at night, and a battery storage system to allow the system to operate at night when it will take less cooling to form the dew. With such an embodiment, cleaning would occur only when panels are sufficiently dirty and only at night when the dew point is lower so that a minimum amount of energy is used for cleaning. The cleaning sensor system could additionally be setup with a monitoring system, to let operators know the cleanliness of the panels.

Regular water contains minerals which could further contaminate the solar panel. Mechanical cleaning is labor intensive and costly. In areas where water is in short supply, RO water for cleaning would be expensive.

A different cooling system/water condenser could be used to make the water.

Alternatively, a similar device could be used for cleaning windows or any similar surface which could be cleaned/rinsed with water. For such an embodiment, instead of a Peltier refrigerator attached to a solar panel, the Peltier refrigerator 20 would be attached to the top edge 11 of a window 10 and the water would flow down to the bottom edge 12. The waste water could also be collected and filtered for re-use. Such an embodiment might be particularly useful for cleaning windows that are difficult, expensive, or dangerous to clean.

Peltier generators have a limited cooling capacity. If they cannot cool below dewpoint, it will not work. For extreme applications, stacked Peltier generators can be used. An embodiment can maximize solar panel output by determining when to use a Peltier cooler to generate condensate to rinse dust from a solar panel's surface.

Certain embodiments could generally operate in accordance with one or more of the following formulas:
2260 KJ/Kg of water.
2260 J/g of water
J=Ws
Peltier=82 Watts
2260=82*s->s=2260/82
27.5 seconds to produce a gram of water=ml
12V, 1 Ah battery=12 Wh=43200 Ws
43200J/2260(J/g)=19 g or 19 ml of water
12V, 12 Ah battery=229 ml
82 Watts, 144 Wh=1.75 hours to produce 229 ml˜8 oz cup
225 W->1125 Wh of energy in a standard configuration or
1462.5 Wh in an MPPT configuration.
144 Watt hours would be 10% of the energy produced in a day.

When configuring an embodiment, the following should be considered:

1. How much Water is needed to clean a solar panel by dripping/spraying water onto it?
2. How often much efficiency gain?
3. How often to run the cleaning cycle?
4. What size Peltier refrigerator should be used?

Methods to automatically clean solar panels could comprise combinations of the following steps:

Using a battery to store energy from a solar panel;
Using a light sensor to determine dirtiness of the solar panel;
Using said light sensor to determine when sunset occurs;
Determining when dirtiness of the solar panel is sufficient to initiate solar panel cleaning;
When the solar panel is sufficiently dirty and shortly after sunset occurs, closing a switch connecting said battery to stacked Peltier refrigerators and thereby turning on said stacked Peltier refrigerators;
Using said stacked Peltier refrigerators to condense water from the atmosphere thereby forming condensed water at the top of said solar panel;
Using said condensed water to rinse said solar panel;
Moving a squeegee over the surface of said solar panel;
Collecting said condensed water at the bottom of said solar panel;
Filtering said collected condensed water;
Storing said condensed water in a pressure vessel; and
Spraying said condensed water from said pressure vessel onto said solar panel.

1. A method to automatically clean solar panels comprising the steps:
Using a battery to store energy from a solar panel;
Using a light sensor to determine dirtiness of the solar panel;
Using said light sensor to determine when sunset occurs;
Determining when dirtiness of the solar panel is sufficient to initiate solar panel cleaning;
When the solar panel is sufficiently dirty and shortly after sunset occurs, closing a switch connecting said battery to stacked Peltier refrigerators and thereby turning on said stacked Peltier refrigerators;
Using said stacked Peltier refrigerators to condense water from the atmosphere thereby forming condensed water at the top of said solar panel;
Using said condensed water to rinse said solar panel;
Moving a squeegee over the surface of said solar panel;
Collecting said condensed water at the bottom of said solar panel;
Filtering said collected condensed water;
Storing said condensed water in a pressure vessel; and
Spraying said condensed water from said pressure vessel onto said solar panel.

2. A solar panel cleaning device comprises a Peltier refrigerator mounted onto the top of a solar panel wherein the Peltier refrigerator is positioned such that condensation formed by the Peltier refrigerator will flow over the solar panel's surface.
